(19) United States
(12) Patent Application Publication
(10) Pub. No.: US 2025/0323375 A1
(43) Pub. Date: Oct. 16, 2025

(54) ACTIVE BREATHING VENT CONTROL FOR A VEHICLE BATTERY PACK

(71) Applicant: GM Global Technology Operations LLC, Detroit, MI (US)

(72) Inventors: Ryan Patrick Hickey, Austin, TX (US); Russell A. Patenaude, Macomb Township, MI (US); Karl Chanler Dorgan, West Bloomfield, MI (US)

(21) Appl. No.: 18/631,417

(22) Filed: Apr. 10, 2024

(51) Int. Cl. H01M 50/317

(52) U.S. Cl. CPC H01M 50/317; H01M 2220/20

(57) ABSTRACT

A method for controlling a breathing vent for a battery pack of a vehicle may include determining a pressure differential between an interior pressure in an interior of the battery pack and an exterior pressure on an exterior of the battery pack. The method further may include controlling the breathing vent to equalize the interior pressure with the exterior pressure based at least in part on the pressure differential.

### INTRODUCTION

The present disclosure relates to systems and methods for regulating pressure in a battery pack.

To enhance performance and reliability, battery packs may be sealed to mitigate moisture ingress. Accordingly, changes in elevation can create a pressure differential between air inside the battery pack and the atmosphere. Therefore, battery packs are equipped with breathing vents that are configured to regulate pressure within the pack, preventing over-pressurization or vacuum conditions which could compromise the integrity of the battery pack. Current breathing vents may utilize gas-permeable membranes to allow pressure exchange while mitigating moisture ingress. However, current breathing vents may not optimally mitigate moisture ingress in all situations. For example, wet environmental conditions such as precipitation, flooding, and/or the like may overwhelm the gas-permeable membrane, causing water ingress into the battery pack. Furthermore, humidity may build up inside the battery pack over the life of the battery pack. Current breathing vents may not have a capability to vent the battery pack when environmental conditions are advantageous to dry the battery pack.

Thus, while battery pack breathing systems and methods achieve their intended purpose, there is a need for a new and improved system and method for controlling a breathing vent for a battery pack.

### SUMMARY

According to several aspects, a method for controlling a breathing vent for a battery pack of a vehicle is provided. The method may include determining a pressure differential between an interior pressure in an interior of the battery pack and an exterior pressure on an exterior of the battery pack. The method further may include controlling the breathing vent to equalize the interior pressure with the exterior pressure based at least in part on the pressure differential.

In another aspect of the present disclosure, controlling the breathing vent further may include comparing the pressure differential to an intermediate-pressure differential threshold. Controlling the breathing vent further may include determining a breathing readiness state in response to determining that the pressure differential is greater than or equal to the intermediate-pressure differential threshold. The breathing readiness state includes one of: a breathing ready state and a breathing not-ready state. Controlling the breathing vent further may include performing a pressure-relief breathing operation in response to determining that the breathing readiness state is the breathing ready state.

In another aspect of the present disclosure, determining the breathing readiness state further may include identifying a moisture condition near the exterior of the battery pack. The moisture condition includes one of: a wet condition and a dry condition. Determining the breathing readiness state further may include determining the breathing readiness state to be the breathing ready state in response to determining that the moisture condition is the dry condition. Determining the breathing readiness state further may include determining the breathing readiness state to be the breathing not-ready state in response to determining that the moisture condition is the wet condition.

In another aspect of the present disclosure, identifying the moisture condition further may include determining a weather condition in an environment surrounding the vehicle. The weather condition includes one of: a precipitation condition and a non-precipitation condition. Identifying the moisture condition further may include identifying the moisture condition to be the wet condition in response to determining that the weather condition is the precipitation condition.

In another aspect of the present disclosure, determining the weather condition further may include performing a moisture measurement using at least one of a vehicle exterior moisture sensor and a vehicle camera. Determining the weather condition further may include determining the weather condition based at least in part on the moisture measurement.

In another aspect of the present disclosure, determining the breathing readiness state further may include determining a motion state of the vehicle. The motion state includes one of: a moving state and a still state. Determining the breathing readiness state further may include determining the breathing readiness state to be the breathing not-ready state in response to determining that the motion state is the moving state.

In another aspect of the present disclosure, determining the motion state further may include identifying an over-the-air (OTA) update event status. The OTA update event status includes one of: an updating status and a not-updating status. Determining the motion state further may include determining the motion state of the vehicle to be the still state in response to determining that the OTA update event status is the updating status.

In another aspect of the present disclosure, controlling the breathing vent further may include comparing the pressure differential to a low-pressure differential threshold. Controlling the breathing vent further may include planning a future pressure-relief breathing operation in response to determining that the pressure differential is greater than or equal to the low-pressure differential threshold. Planning the future pressure-relief breathing operation further may include identifying one or more predicted vehicle stopping events. Planning the future pressure-relief breathing operation further may include planning the future pressure-relief breathing operation to occur during one of the one or more predicted vehicle stopping events.

In another aspect of the present disclosure, the method further may include measuring an interior humidity in the interior of the battery pack. The method further may include measuring an exterior humidity on the exterior of the battery pack. The method further may include performing a humidity-relief breathing operation in response to determining that the interior humidity is greater than the exterior humidity.

In another aspect of the present disclosure, the method further may include comparing the pressure differential to a high-pressure differential threshold. The method further may include performing a pressure-relief breathing operation in response to determining that the pressure differential is greater than or equal to the high-pressure differential threshold.

According to several aspects, a system for controlling a breathing vent for a battery pack of a vehicle is provided. The system may include the battery pack including an interior pressure sensor disposed in an interior of the battery pack, an exterior pressure sensor disposed on an exterior of the battery pack, and the breathing vent. The breathing vent is actively controllable to regulate airflow between the interior of the battery pack and the exterior of the battery pack. The system further may include a controller in electrical communication with the interior pressure sensor, the exterior pressure sensor, and the breathing vent. The controller is programmed to measure an interior pressure using the interior pressure sensor. The controller is further programmed to measure an exterior pressure using the exterior pressure sensor. The controller is further programmed to determine a pressure differential between the interior pressure and the exterior pressure. The controller is further programmed to control the breathing vent to equalize the interior pressure with the exterior pressure based at least in part on the pressure differential.

In another aspect of the present disclosure, to control the breathing vent, the controller is further programmed to compare the pressure differential to an intermediate-pressure differential threshold. To control the breathing vent, the controller is further programmed to compare the pressure differential to a high-pressure differential threshold. The high-pressure differential threshold is greater than the intermediate-pressure differential threshold. To control the breathing vent, the controller is further programmed to determine a breathing readiness state in response to determining that the pressure differential is greater than or equal to the intermediate-pressure differential threshold. The breathing readiness state includes one of: a breathing ready state and a breathing not-ready state. To control the breathing vent, the controller is further programmed to perform a pressure-relief breathing operation in response to determining that the breathing readiness state is the breathing ready state. To control the breathing vent, the controller is further programmed to perform the pressure-relief breathing operation in response to determining that the pressure differential is greater than or equal to the high-pressure differential threshold.

In another aspect of the present disclosure, to determine the breathing readiness state, the controller is further programmed to identify a moisture condition near the exterior of the battery pack. The moisture condition includes one of: a wet condition and a dry condition. To determine the breathing readiness state, the controller is further programmed to determine the breathing readiness state to be the breathing ready state in response to determining that the moisture condition is the dry condition. To determine the breathing readiness state, the controller is further programmed to determine the breathing readiness state to be the breathing not-ready state in response to determining that the moisture condition is the wet condition.

In another aspect of the present disclosure, the system further may include at least one of: a vehicle exterior moisture sensor in electrical communication with the controller and a vehicle camera in electrical communication with the controller. To identify the moisture condition, the controller is further programmed to perform a moisture measurement using at least one of: the vehicle exterior moisture sensor and the vehicle camera. To identify the moisture condition, the controller is further programmed to determine the moisture condition based at least in part on the moisture measurement.

In another aspect of the present disclosure, the controller is further programmed to determine a motion state of the vehicle. The motion state includes one of: a moving state and a still state. The controller is further programmed to determine the breathing readiness state to be the breathing not-ready state in response to determining that the moisture condition is the wet condition and the motion state is the moving state.

In another aspect of the present disclosure, to determine the motion state of the vehicle, the controller is further programmed to identify an over-the-air (OTA) update event status. The OTA update event status includes one of: an updating status and a not-updating status. To determine the motion state of the vehicle, the controller is further programmed to determine the motion state of the vehicle to be the still state in response to determining that the OTA update event status is the updating status.

In another aspect of the present disclosure, the battery pack further includes an interior humidity sensor in electrical communication with the controller and disposed in the interior of the battery pack and an exterior humidity sensor in electrical communication with the controller and disposed on the exterior of the battery pack. The controller is further programmed to measure an interior humidity using the interior humidity sensor. The controller is further programmed to measure an exterior humidity using the exterior humidity sensor. The controller is further programmed to perform a humidity-relief breathing operation in response to determining that the interior humidity is greater than the exterior humidity.

According to several aspects, a method for controlling a breathing vent for a battery pack of a vehicle is provided. The method may include determining a pressure differential between an interior pressure in an interior of the battery pack and an exterior pressure on an exterior of the battery pack. The method further may include measuring an interior humidity in the interior of the battery pack and an exterior humidity on the exterior of the battery pack. The method further may include comparing the pressure differential to an intermediate-pressure differential threshold. The method further may include determining a breathing readiness state in response to determining that the pressure differential is greater than or equal to the intermediate-pressure differential threshold. The breathing readiness state includes one of: a breathing ready state and a breathing not-ready state. The method further may include comparing the pressure differential to a high-pressure differential threshold. The high-pressure differential threshold is greater than the intermediate-pressure differential threshold. The method further may include performing a pressure-relief breathing operation in response to determining that the breathing readiness state is the breathing ready state or the pressure differential is greater than or equal to the high-pressure differential threshold. The method further may include performing a humidity-relief breathing operation in response to determining that the interior humidity is greater than the exterior humidity and the breathing readiness state is the breathing ready state.

In another aspect of the present disclosure, determining the breathing readiness state further may include identifying a moisture condition near the exterior of the battery pack. The moisture condition includes one of: a wet condition and a dry condition. Determining the breathing readiness state further may include determining a motion state of the vehicle. The motion state includes one of: a moving state and a still state. Determining the breathing readiness state further may include determining the breathing readiness state to be the breathing ready state in response to determining that the moisture condition is the dry condition or the motion state is the still state. Determining the breathing readiness state further may include determining the breathing readiness state to be the breathing not-ready state in response to determining that the moisture condition is the wet condition and the motion state is the moving state.

In another aspect of the present disclosure, the method further may include comparing the pressure differential to a low-pressure differential threshold. The method further may include planning a future pressure-relief breathing operation in response to determining that the pressure differential is greater than or equal to the low-pressure differential threshold. Planning the future pressure-relief breathing operation further may include identifying one or more predicted vehicle stopping events. Planning the future pressure-relief breathing operation further may include planning the future pressure-relief breathing operation to occur during one of the one or more predicted vehicle stopping events.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for controlling a breathing vent for a battery pack of a vehicle, according to an exemplary embodiment;

FIG. 2 is a flowchart of a method for controlling a breathing vent for a battery pack of a vehicle, according to an exemplary embodiment;

FIG. 3 is a flowchart of method for determining a breathing readiness state, according to an exemplary embodiment; and

FIG. 4 is a method for planning a future pressure-relief breathing operation, according to an exemplary embodiment.

### DETAILED DESCRIPTION

The following description is merely exemplary in nature and is not intended to limit the present disclosure, application, or uses.

In aspects of the present disclosure, it is advantageous to mitigate ingress of moisture into a battery enclosure to increase the performance, reliability and lifespan of the battery system. Accordingly, the battery enclosure may be partially or fully hermetically sealed to prevent moisture ingress. However, sealed battery enclosures may experience dynamic pressure forces due to elevation changes during the life of the battery system. Therefore, the present disclosure provides a new and improved system and method for controlling a breathing vent for a battery pack which allows for pressure equalization while minimizing moisture ingress.

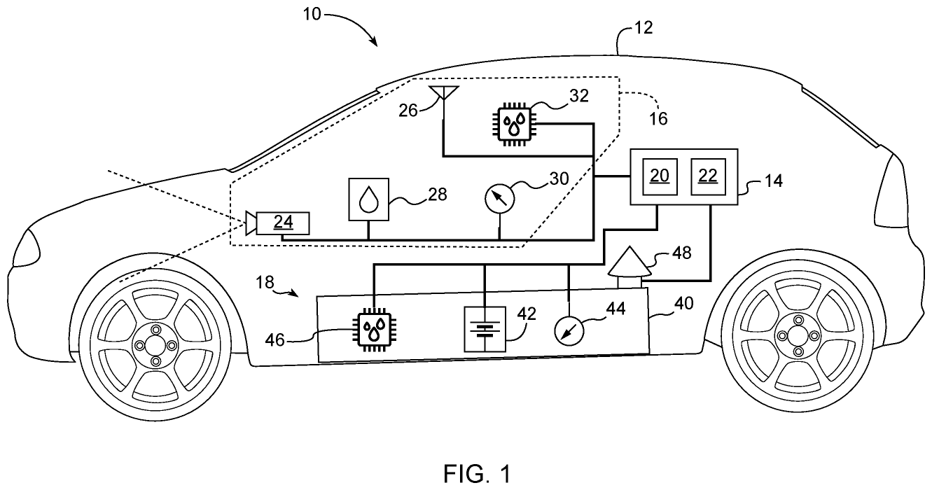

Referring to FIG. 1, a system for controlling a breathing vent for a battery pack of a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, a plurality of vehicle sensors 16, and a battery pack 18.

The controller 14 is used to implement a method 100 for controlling a breathing vent for a battery pack of a vehicle, as will be described below. The controller 14 includes at least one processor 20 and a non-transitory computer readable storage device or media 22. The processor 20 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions.

The computer readable storage device or media 22 may include volatile and nonvolatile storage in read-only memory (ROM), random-access memory (RAM), and keep-alive memory (KAM), for example. KAM is a persistent or non-volatile memory that may be used to store various operating variables while the processor 20 is powered down. The computer-readable storage device or media 22 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12.

The controller 14 may also consist of multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the plurality of vehicle sensors 16 and the battery pack 18. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

The plurality of vehicle sensors 16 are used to acquire information relevant to the vehicle 12. In an exemplary embodiment, the plurality of vehicle sensors 16 includes a vehicle camera 24, a vehicle communication system 26, a vehicle exterior moisture sensor 28, an exterior pressure sensor 30, and an exterior humidity sensor 32. In another exemplary embodiment, the plurality of vehicle sensors 16 further includes sensors to determine performance data about the vehicle 12. In a non-limiting example, the plurality of vehicle sensors 16 further includes at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor. The plurality of vehicle sensors 16 are in electrical communication with the controller 14 as discussed above.

The vehicle camera 24 is a perception sensor used to capture images and/or videos of an environment surrounding the vehicle 12. In an exemplary embodiment, the vehicle camera 24 includes a photo and/or video camera which is positioned to view the environment surrounding the vehicle 12. In a non-limiting example, the vehicle camera 24 includes a camera affixed inside of the vehicle 12, for example, in a headliner of the vehicle 12, having a view through the windscreen. In another non-limiting example, the vehicle camera 24 includes a camera affixed outside of the vehicle 12, for example, on a roof of the vehicle 12, having a view of the environment in front of the vehicle 12.

In another exemplary embodiment, the vehicle camera 24 is a surround view camera system including a plurality of cameras (also known as satellite cameras) arranged to provide a view of the environment adjacent to all sides of the vehicle 12. In a non-limiting example, the vehicle camera 24 includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the vehicle camera 24 further includes an additional rear-view camera mounted near a center high mounted stop lamp of the vehicle 12.

It should be understood that camera systems having additional cameras and/or additional mounting locations are within the scope of the present disclosure. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The vehicle communication system 26 is used by the controller 14 to communicate with other systems external to the vehicle 12. For example, the vehicle communication system 26 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems). In certain embodiments, the vehicle communication system 26 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like).

Accordingly, the vehicle communication system 26 may further include an embedded universal integrated circuit card (eUICC) configured to store at least one cellular connectivity configuration profile, for example, an embedded subscriber identity module (eSIM) profile. The vehicle communication system 26 is further configured to communicate via a personal area network (e.g., BLUETOOTH), near-field communication (NFC), and/or any additional type of radiofrequency communication.

However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

Accordingly, the vehicle communication system 26 may include one or more antennas and/or communication transceivers for receiving and/or transmitting signals, such as cooperative sensing messages (CSMs). The vehicle communication system 26 is configured to wirelessly communicate information between the vehicle 12 and another vehicle. Further, the vehicle communication system 26 is configured to wirelessly communicate information between the vehicle 12 and infrastructure or other vehicles. It should be understood that the vehicle communication system 26 may be integrated with the controller 14 (e.g., on a same circuit board with the controller 14 or otherwise a part of the controller 14) without departing from the scope of the present disclosure.

The vehicle exterior moisture sensor 28 is used to detect the occurrence of precipitation (e.g., rain, hail, sleet, snow, etc.) on the vehicle 12. In an exemplary embodiment, the vehicle exterior moisture sensor 28 includes one or more moisture-sensitive elements disposed on an exterior surface of the vehicle 12. In a non-limiting example, the one or more moisture-sensitive elements utilize capacitive or resistive sensing principles to detect moisture. The controller 14 uses the vehicle exterior moisture sensor 28 to continuously monitor moisture levels on the exterior surface of the vehicle 12. The controller 14 may then identify the occurrence of precipitation based on the moisture levels. The vehicle exterior moisture sensor 28 is in electrical communication with the controller 14 as discussed above.

The exterior pressure sensor 30 is used to measure an exterior pressure. In the scope of the present disclosure, the exterior pressure is the atmospheric air pressure in the environment surrounding the vehicle 12. Atmospheric air pressure in the environment surrounding the vehicle 12 may vary due to weather conditions and/or elevation changes. In an exemplary embodiment, the exterior pressure sensor 30 includes a sensing element, such as, for example, a piezoelectric, capacitive, micro-electro-mechanical system (MEMS), or strain gauge sensing element and associated electronic circuitry for signal processing and output. When atmospheric pressure is applied to the sensing element, the sensing element undergoes a physical change, such as deformation or capacitance variation, which alters the electrical properties of the exterior pressure sensor 30. The electronic circuitry then processes these changes to produce an output signal proportional to the atmospheric pressure. In an exemplary embodiment, the exterior pressure sensor 30 is disposed on an exterior of the vehicle 12. The exterior pressure sensor 30 is in electrical communication with the controller 14 as discussed above.

The exterior humidity sensor 32 is used to measure a relative humidity (RH) and/or absolute humidity (AH) of air in the environment surrounding the vehicle 12. In an exemplary embodiment, the exterior humidity sensor 32 includes a sensing element, such as, for example, a capacitive, resistive, thermal, micro-electro-mechanical system (MEMS), or optical sensing element and associated electronic circuitry for signal processing and output. In a non-limiting example, the sensing element includes a hygroscopic material which absorbs or releases water vapor depending on the humidity level, causing changes in electrical resistance or capacitance of the sensing element. The electronic circuitry processes changes in the electrical properties of the sensing element to produce an output signal proportional to the humidity level. In an exemplary embodiment, the exterior humidity sensor 32 is disposed on an exterior of the vehicle 12. In a non-limiting example, the exterior humidity sensor 32 is disposed proximally to the battery pack 18, such as to measure a humidity directly outside of the battery pack 18. The exterior humidity sensor 32 is in electrical communication with the controller 14 as discussed above.

The battery pack 18 stores and provides electrical energy in the form of direct current (DC) for propulsion of the vehicle 12. In an exemplary embodiment, the battery pack 18 includes an enclosure 40, a plurality of battery cells 42, an interior pressure sensor 44, an interior humidity sensor 46, and a breathing vent 48. It should be understood that the battery pack 18 further may include additional components such as, for example, power electronic components (e.g., DC/DC converters, inverters, battery management systems, contactors, fuses, and/or the like), temperature regulation components (e.g., active/passive heating/cooling systems and components), additional sensors, and/or the like without departing from the scope of the present disclosure.

The enclosure 40 is configured to protect the components of the battery pack 18 from mechanical vibration, water intrusion, and dust intrusion. In an exemplary embodiment, the enclosure 40 is made from a metal material (e.g., steel, aluminum, and/or the like) and/or composite material (e.g., plastic, carbon fiber, fiberglass, and/or the like). To optimize performance and lifespan of the plurality of battery cells 42 and other electrical components within the enclosure 40, it is advantageous to minimize a humidity of the air trapped within the enclosure 40. In an exemplary embodiment, in order to effectively mitigate water intrusion, the enclosure 40 is partially or fully hermetically sealed. Therefore, the breathing vent 48 is used to allow equalization of an air pressure of air trapped within the enclosure 40 with the atmosphere, as will be discussed in greater detail below. In the scope of the present disclosure, an interior of the battery pack 18 refers to an area within the enclosure 40 (i.e., an interior of the enclosure 40). An exterior of the battery pack 18 refers to any area outside of the enclosure 40 (i.e., an exterior of the enclosure 40, e.g., the environment surrounding the vehicle 12).

The plurality of battery cells 42 are used to store and release electrical energy for operation (e.g., propulsion) of the vehicle 12. In an exemplary embodiment, the plurality of battery cells 42 (e.g., lithium-ion battery cells) are electrically connected in series and/or parallel to provide an increased voltage and/or current-carrying capacity. It should be understood that the plurality of battery cells 42 may include any number, type, chemistry, capacity, and/or form-factor, battery cells without departing from the scope of the present disclosure.

The interior pressure sensor 44 is used to measure an interior pressure. In the scope of the present disclosure the interior pressure is an air pressure of the air trapped within the enclosure 40. In an exemplary embodiment, the interior pressure sensor 44 includes a sensing element, such as, for example, a piezoelectric, capacitive, micro-electro-mechanical system (MEMS), or strain gauge sensing element and associated electronic circuitry for signal processing and output. When air pressure is applied to the sensing element, the sensing element undergoes a physical change, such as deformation or capacitance variation, which alters the electrical properties of the interior pressure sensor 44. The electronic circuitry then processes these changes to produce an output signal proportional to the air pressure. In an exemplary embodiment, the interior pressure sensor 44 is disposed within the enclosure 40 of the battery pack 18. The interior pressure sensor 44 is in electrical communication with the controller 14 as discussed above.

The interior humidity sensor 46 is used to measure a relative humidity (RH) and/or absolute humidity (AH) of the air trapped within the enclosure 40. In an exemplary embodiment, the interior humidity sensor 46 includes a sensing element, such as, for example, a capacitive, resistive, thermal, micro-electro-mechanical system (MEMS), or optical sensing element and associated electronic circuitry for signal processing and output. In a non-limiting example, the sensing element includes a hygroscopic material which absorbs or releases water vapor depending on the humidity level, causing changes in electrical resistance or capacitance of the sensing element. The electronic circuitry processes changes in the electrical properties of the sensing element to produce an output signal proportional to the humidity level. In an exemplary embodiment, the interior humidity sensor 46 is disposed within the enclosure 40 of the battery pack 18. The interior humidity sensor 46 is in electrical communication with the controller 14 as discussed above.

The breathing vent 48 is used to equalize air pressure between the interior of the battery pack 18 and the exterior of the battery pack 18. In an exemplary embodiment, it is advantageous to equalize air pressure between the interior of the battery pack 18 and the exterior of the battery pack 18 to mitigate pressure forces on the enclosure 40 which may result in damage (e.g., loss of hermetic seal) to the enclosure 40. In an exemplary embodiment, the breathing vent 48 is disposed in a penetration of the enclosure 40, allowing fluid communication between the interior of the enclosure 40 and the exterior of the enclosure 40. In a non-limiting example, the breathing vent 48 includes a fluid-tight, electrically controllable valve in electrical communication with the controller 14. The electrically controllable valve may be commanded by the controller 14 to partially or fully open, allowing airflow between the interior of the enclosure 40 and the exterior of the enclosure 40. It should be understood that any type of electrically controllable valve, vent, seal, flap, opening, and/or the like is within the scope of the present disclosure.

The electrically controllable valve may also be commanded by the controller 14 to close, preventing airflow between the interior of the enclosure 40 and the exterior of the enclosure 40 and isolating the interior of the enclosure 40 from water/moisture ingress. Therefore, the breathing vent 48 is actively controllable to regulate airflow between the interior of the battery pack 18 and the exterior of the battery pack 18.

In an exemplary embodiment, the breathing vent 48 further includes a gas-permeable membrane configured to allow passage of gas but prevent passage of liquids. Therefore, even when the electrically controllable valve is partially or fully open, the ingress of liquid water is mitigated by the gas-permeable membrane. The electrically controllable valve of the breathing vent 48 is in electrical communication with the controller 14 as discussed above.

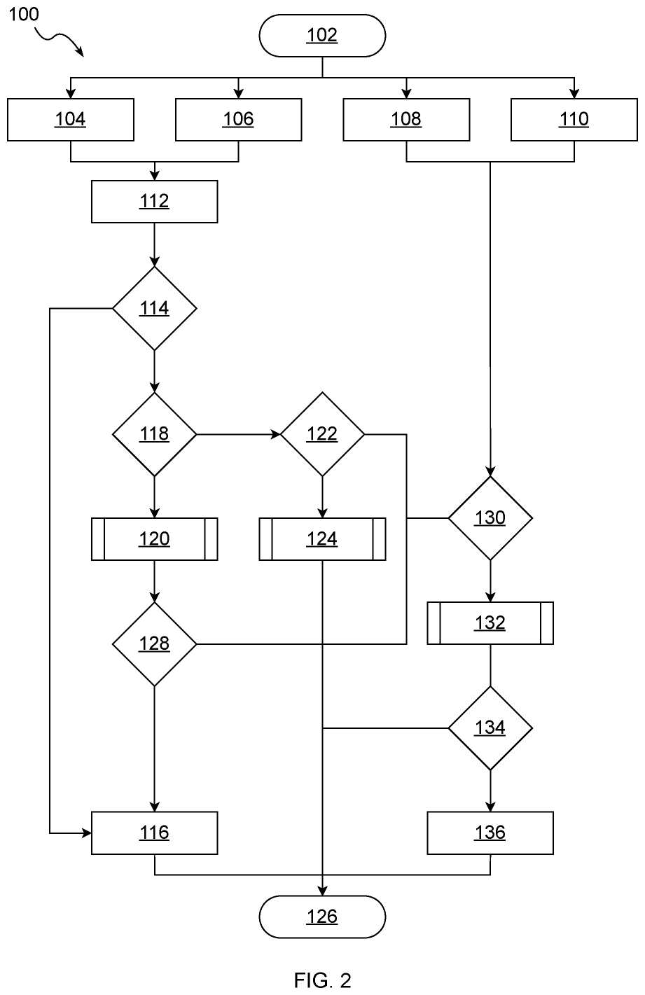

Referring to FIG. 2, a flowchart of the method 100 for controlling a breathing vent for a battery pack of a vehicle is shown. The method 100 beings at block 102 and proceeds to blocks 104, 106, 108, and 110. At block 104, the controller 14 uses the interior pressure sensor 44 to measure the interior pressure of the air within the enclosure 40 of the battery pack 18. After block 104, the method 100 proceeds to block 112, as will be discussed in greater detail below.

At block 106, the controller 14 uses the exterior pressure sensor 30 to measure the exterior pressure of the air in the environment surrounding the vehicle 12 (i.e., the atmospheric air pressure). After block 106, the method 100 proceeds to block 112.

At block 112, the controller 14 determines a pressure differential between the interior pressure measured at block 104 and the exterior pressure measured at block 106. In a non-limiting example, the pressure differential is an absolute value of a difference between the interior pressure and the exterior pressure. In some embodiments, the pressure differential is estimated based on an estimated elevation change of the vehicle 12 (e.g., as determined using one or more of the plurality of vehicle sensors 16). After block 112, the method 100 proceeds to block 114.

At block 114, the controller 14 compares the pressure differential determined at block 112 to a high-pressure differential threshold. In the scope of the present disclosure, the high-pressure differential threshold is a pressure differential requiring immediate pressure equalization to prevent damage to the enclosure 40 or other components of the battery pack 18. In a non-limiting example, the high-pressure differential threshold is five kilopascals (kPa). It should be understood that the high-pressure differential threshold may be determined based on experimental data, computer simulation, theoretical calculation, and/or the like, and that values provided herein are merely exemplary in nature. If the pressure differential is greater than or equal to the high-pressure differential threshold, the method 100 proceeds to block 116, as will be discussed in greater detail below. If the pressure differential is less than the high-pressure differential threshold, the method 100 proceeds to block 118.

At block 118, the controller 14 compares the pressure differential determined at block 112 to an intermediate-pressure differential threshold. In the scope of the present disclosure, the intermediate-pressure differential threshold is a pressure differential which is tolerable for at least a first time period (e.g., one or more weeks, one or more days, one or more hours, and/or the like). In an exemplary embodiment, the intermediate-pressure differential threshold is less than the high-pressure differential threshold. In a non-limiting example, the intermediate-pressure differential threshold is three kilopascals (kPa). It should be understood that the intermediate-pressure differential threshold and the first time period may be determined based on experimental data, computer simulation, theoretical calculation, and/or the like, and that values provided herein are merely exemplary in nature. If the pressure differential is greater than or equal to the intermediate-pressure differential threshold, the method 100 proceeds to block 120, as will be discussed in greater detail below. If the pressure differential is less than the intermediate-pressure differential threshold, the method 100 proceeds to block 122.

At block 122, the controller 14 compares the pressure differential determined at block 112 to a low-pressure differential threshold. In the scope of the present disclosure, the low-pressure differential threshold is a pressure differential which is tolerable for at least a second time period (e.g., one or more minutes, one or more seconds, one or more milliseconds, and/or the like). In the scope of the present disclosure, the second time period is less than the first time period discussed above in reference to block 118. In an exemplary embodiment, the low-pressure differential threshold is less than the intermediate-pressure differential threshold. In a non-limiting example, the low-pressure differential threshold is one kilopascal (kPa). It should be understood that the low-pressure differential threshold and the second time period may be determined based on experimental data, computer simulation, theoretical calculation, and/or the like, and that values provided herein are merely exemplary in nature. If the pressure differential is greater than or equal to the low-pressure differential threshold, the method 100 proceeds to block 124. If the pressure differential is less than the low-pressure differential threshold, the method 100 proceeds to enter a standby state at block 126.

At block 124, the controller 14 plans a future pressure-relief breathing operation, as will be discussed in greater detail below. After block 124, the method 100 proceeds to enter the standby state at block 126.

At block 120, the controller 14 determines a breathing readiness state. In an exemplary embodiment, the breathing readiness state includes one of: a breathing ready state and a breathing not-ready state. In the scope of the present disclosure, the breathing ready state indicates that conditions are favorable for a breathing operation to occur. In an exemplary embodiment, conditions allowing for the mitigation of moisture entry into the enclosure 40 are favorable. The breathing not-ready state indicates that conditions are unfavorable for a breathing operation to occur. In an exemplary embodiment, conditions potentially resulting in moisture entry into the enclosure 40 are unfavorable. Determination of the breathing readiness state will be discussed in greater detail below. After block 120, the method 100 proceeds to block 128.

At block 128, if the breathing readiness state determined at block 120 is the breathing ready state, the method 100 proceeds to block 116. If the breathing readiness state determined at block 120 is the breathing not-ready state, the method 100 proceeds to enter the standby state at block 126.

At block 116, the controller 14 performs a pressure-relief breathing operation. The pressure-relief breathing operation includes actuation of the breathing vent 48 to equalize the interior pressure measured at block 104 with the exterior pressure measured at block 106. In an exemplary embodiment, the controller 14 sends an electrical signal to the breathing vent 48 to open and close the electrically controllable valve. In a non-limiting example, the electrically controllable valve is opened for a first predetermined opening time period (e.g., one second). In another non-limiting example, the interior pressure and the exterior pressure are monitored after opening the electrically controllable valve and the electrically controllable valve remains open until the interior pressure and the exterior pressure are substantially equalized. It should be understood that additional methods for actuating the breathing vent 48 to equalize the interior pressure with the exterior pressure, including, for example, partial opening of the electrically controllable valve are within the scope of the present disclosure. After block 116, the method 100 proceeds to enter the standby state at block 126.

At block 108, the controller 14 uses the interior humidity sensor 46 to measure the interior humidity of the air within the enclosure 40 of the battery pack 18. After block 108, the method 100 proceeds to block 130, as will be discussed in greater detail below.

At block 110, the controller 14 uses the exterior humidity sensor 32 to measure the exterior humidity of the air in the environment surrounding the vehicle 12. After block 110, the method 100 proceeds to block 130.

At block 130, the controller 14 compares the interior humidity measured at block 108 to the exterior humidity measured at block 110. If the interior humidity is greater than the exterior humidity by at least a predetermined threshold, the method 100 proceeds to block 132. If the interior humidity is not greater than the exterior humidity by at least the predetermined threshold, the method 100 proceeds to enter the standby state at block 126.

At block 132, the controller 14 determines the breathing readiness state. As discussed above, the breathing readiness state includes one of: the breathing ready state and the breathing not-ready state. In the scope of the present disclosure, the breathing ready state indicates that conditions are favorable for a breathing operation to occur. In an exemplary embodiment, conditions allowing for the mitigation of moisture entry into the enclosure 40 are favorable. The breathing not-ready state indicates that conditions are unfavorable for a breathing operation to occur. In an exemplary embodiment, conditions potentially resulting in moisture entry into the enclosure 40 are unfavorable. Determination of the breathing readiness state will be discussed in greater detail below. After block 132, the method 100 proceeds to block 134.

At block 134, if the breathing readiness state determined at block 132 is the breathing ready state, the method 100 proceeds to block 136. If the breathing readiness state determined at block 132 is the breathing not-ready state, the method 100 proceeds to enter the standby state at block 126.

At block 136, the controller 14 performs a humidity-relief breathing operation. The humidity-relief breathing operation includes actuation of the breathing vent 48 to decrease the humidity of the air within the enclosure 40. In an exemplary embodiment, the controller 14 sends an electrical signal to the breathing vent 48 to open and close the electrically controllable valve. In a non-limiting example, the electrically controllable valve is opened for a second predetermined opening time period (e.g., one minute). In a non-limiting example, the second predetermined opening time period is greater than the first predetermined opening time period discussed above in reference to block 116. In another non-limiting example, the interior humidity and the exterior humidity are monitored after opening the electrically controllable valve and the electrically controllable valve remains open until the interior humidity and the exterior humidity are substantially equalized and/or the interior humidity is substantially decreased. It should be understood that additional methods for actuating the breathing vent 48 to decrease the humidity of the air within the enclosure 40, including, for example, partial opening of the electrically controllable valve are within the scope of the present disclosure. After block 136, the method 100 proceeds to enter the standby state at block 126.

In an exemplary embodiment, the controller 14 repeatedly exits the standby state 126 and restarts the method 100 at block 102. In a non-limiting example, the controller 14 exits the standby state 126 and restarts the method 100 on a timer, for example, every three hundred milliseconds, allowing for continuous monitoring of pressure and humidity.

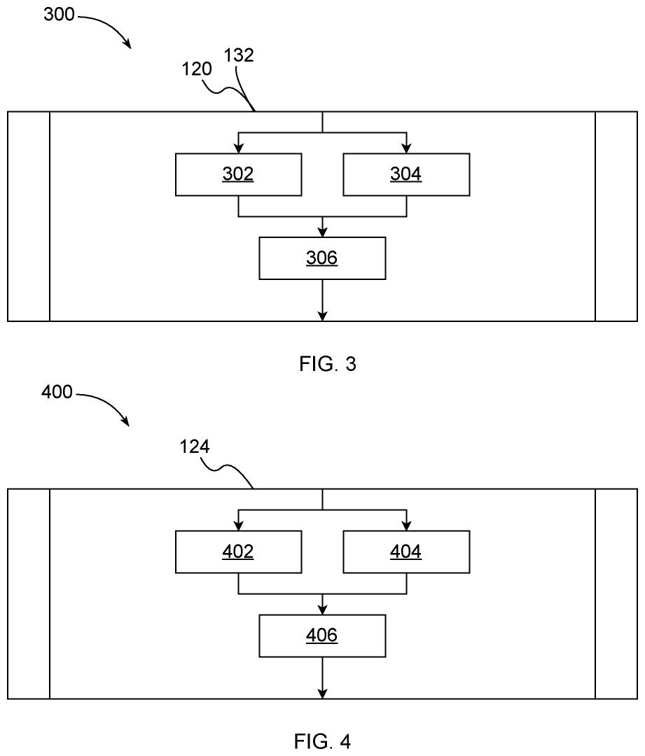

Referring to FIG. 3, a flowchart of an exemplary embodiment 300 of blocks 120 and 132 (i.e., a method for determining a breathing readiness state) is shown. The exemplary embodiment 300 begins at blocks 302 and 304. At block 302, the controller 14 identifies a moisture condition near the exterior of the battery pack 18. In an exemplary embodiment, the moisture condition includes one of: a wet condition and a dry condition. In the scope of the present disclosure, the wet condition indicates a presence of liquid water near the battery pack 18 and/or in the environment surrounding the vehicle 12. The dry condition indicates an absence of liquid water near the battery pack 18 and/or in the environment surrounding the vehicle 12.

In a first exemplary embodiment, to determine the moisture condition, the controller 14 determines a weather condition in the environment surrounding the vehicle 12. In an exemplary embodiment, the weather condition includes one of: a precipitation condition and a non-precipitation condition. In the scope of the present disclosure, the precipitation condition indicates that precipitation (e.g., rain, sleet, hail, snow, etc.) is occurring in the environment surrounding the vehicle 12. The non-precipitation condition indicates that precipitation is not occurring in the environment surrounding the vehicle 12. If the weather condition is the precipitation condition, the moisture condition is determined to be the wet condition. If the weather condition is the non-precipitation condition, the moisture condition is determined to be the dry condition.

In a first exemplary embodiment, to determine the weather condition, the controller 14 performs a moisture measurement using the vehicle exterior moisture sensor 28. In a non-limiting example, if moisture is detected by the vehicle exterior moisture sensor 28, the weather condition is determined to be the precipitation condition. If moisture is not detected by the vehicle exterior moisture sensor 28, the weather condition is determined to be the non-precipitation condition.

In a second exemplary embodiment, to determine the weather condition, the controller 14 performs a moisture measurement using the vehicle camera 24. In a non-limiting example, the controller 14 uses the vehicle camera 24 to capture one or more images/videos of the environment surrounding the vehicle 12. The controller 14 then uses computer vision and/or machine learning based techniques to identify signs of precipitation such as puddles or standing water on roadways, moisture on a lens of the vehicle camera 24, and/or visual confirmation of active precipitation (e.g., raindrops, snowflakes, etc.) or other hazards (e.g., road flooding, road salt, debris, etc.). In a non-limiting example, the controller 14 uses a precipitation detection machine learning algorithm to determine the weather condition.

In a non-limiting example, the precipitation detection machine learning algorithm includes multiple layers, including an input layer and an output layer, as well as one or more hidden layers. The input layer receives images/videos of the environment as inputs. The inputs are then passed on to the hidden layers. Each hidden layer applies a transformation (e.g., a non-linear transformation) to the data and passes the result to the next hidden layer until the final hidden layer. The output layer produces the weather condition. To train the precipitation detection machine learning algorithm, a dataset of inputs and their corresponding weather condition is used. The algorithm is trained by adjusting internal weights between nodes in each hidden layer to minimize prediction error. During training, an optimization technique (e.g., gradient descent) is used to adjust the internal weights to reduce the prediction error. The training process is repeated with the entire dataset until the prediction error is minimized, and the resulting trained model is then used to classify new input data. After sufficient training of the precipitation detection machine learning algorithm, the algorithm is capable of accurately and precisely determining the weather condition based on images/videos of the environment. By adjusting the weights between the nodes in each hidden layer during training, the algorithm “learns” to recognize patterns in the data that are indicative of the weather condition.

In a third exemplary embodiment, to determine the weather condition, the controller 14 uses the vehicle communication system 26 to retrieve weather information a remote server. In a non-limiting example, the controller 14 uses the vehicle communication system 26 to transmit a current location of the vehicle 12 (as determined using, for example, a global navigation satellite system (GNSS)) to the remote server. The remote server responds with a message including weather information about the environment surrounding the vehicle 12, including the weather condition (i.e., the precipitation condition or the non-precipitation condition).

It should be understood that additional methods for determining the weather condition and/or moisture condition, including, for example, methods based on the activation/deactivation state of vehicle systems (e.g., windshield wipers, headlights, running lights, fog lights, and/or the like) are within the scope of the present disclosure. In some embodiments, the controller 14 uses navigation route planning information to identify tunnels, overpasses, or other covered areas along the route of the vehicle 12 which may mitigate exposure to moisture. After block 302, the exemplary embodiment 300 proceeds to block 306, as will be discussed in greater detail below.

At block 304, the controller 14 identifies a motion state of the vehicle 12. In an exemplary embodiment, the motion state includes one of: a moving state and a still state. In the scope of the present disclosure, the moving state indicates that the vehicle 12 is in motion (e.g., driving, rolling, etc.). The still state indicates that the vehicle 12 is not in motion (e.g., stopped, parked, etc.).

In a first exemplary embodiment, to determine the motion state, the controller 14 identifies an over-the-air (OTA) update event status. In an exemplary embodiment, the OTA update event status includes one of: an updating status and a not-updating status. In the scope of the present disclosure, the updating status indicates that one or more systems of the vehicle 12 (e.g., the controller 14) is currently performing an OTA update (i.e., downloading/installing a software update from a remote server using the vehicle communication system 26) and that the vehicle 12 is immobilized due to the OTA update process. The not-updating status indicates that no OTA update is currently being performed. In an exemplary embodiment, to determine the OTA update event status, the controller 14 checks for the presence of a software flag saved in the media 22 indicating that an OTA update process is in progress. If the OTA update event status is the updating status, the motion state is determined to be the still state.

In a second exemplary embodiment, to determine the motion state, the controller 14 compares a measured speed of the vehicle 12 to a predetermined stop threshold (e.g., one kilometer per hour). If the speed is less than or equal to the predetermined stop threshold, the motion state is determined to be the still state. In a non-limiting example, the controller 14 uses vehicle-to-everything (V2X) communication to communicate with nearby vehicles and/or traffic control infrastructure to determine an expected duration of the still state based on traffic information and/or phase/timing of traffic control devices. In another non-limiting example, the controller 14 uses pattern analysis techniques such as machine learning techniques to identify long periods during which the vehicle 12 is in the still state (e.g., when the vehicle 12 is parked overnight).

It should be understood that additional methods for determining the motion state are within the scope of the present disclosure. After block 304 the exemplary embodiment 300 proceeds to block 306.

At block 306, the controller 14 determines the breathing readiness state based at least in part on at least one of the moisture condition determined at block 302 and the motion state determined at block 304. In a first exemplary embodiment, the breathing readiness state is determined to be the breathing ready state if the moisture condition is the dry condition and the motion state is the still state. In a second exemplary embodiment, the breathing readiness state is determined to be the breathing ready state if the moisture condition is the dry condition and the motion state is the still state or the moving state. In a third exemplary embodiment, the breathing readiness state is determined to be the breathing ready state if the moisture condition is the wet condition or the dry condition and the motion state is the still state. It should be understood that the above exemplary embodiments are merely illustrative in nature, and that any additional methods of determining the breathing readiness state based at least in part on at least one of the moisture condition and the motion state are within the scope of the present disclosure.

In a non-limiting example, the breathing readiness state is determined using a multidimensional lookup table (LUT) which maps the moisture condition and the motion state to the breathing readiness state. The LUT has two key columns (i.e., one key column for each of the moisture condition and the motion state) and one value column (i.e., one value column for the breathing readiness state). In an exemplary embodiment, the LUT includes a plurality of rows, each of the plurality of rows mapping a unique combination of the moisture condition and the motion state in the 2 key columns to a value in the value column (i.e., the breathing ready state or the breathing not-ready state).

The LUT is stored in the media 22 of the controller 14. In an exemplary embodiment, the plurality of rows of the LUT are predetermined. The LUT may be populated manually or using a machine learning algorithm or generative artificial intelligence software. In another exemplary embodiment, the plurality of rows of the LUT may be updated over-the-air (OTA) using the vehicle communication system 26. It should be understood that any method (e.g., programmatic data structure, logic equation, mathematical function, and/or the like) of mapping a plurality of keys (i.e., the moisture condition and the motion state) to a plurality of values (i.e., the breathing ready state or the breathing not-ready state) is within the scope of the present disclosure. After block 306, the exemplary embodiment 300 is concluded, and the method 100 proceeds as discussed above.

Referring to FIG. 4, a flowchart of an exemplary embodiment 400 of block 124 (i.e., a method for planning a future pressure-relief breathing operation) is shown. The exemplary embodiment 400 begins at blocks 402 and 404. At block 402, the controller 14 predicts a future moisture condition near the exterior of the battery pack 18. In an exemplary embodiment, the future moisture condition includes one of: a future wet condition and a future dry condition. In the scope of the present disclosure, the future wet condition indicates a predicted presence of liquid water near the battery pack 18 and/or in the environment surrounding the vehicle 12 in the near future. The future dry condition indicates a predicted absence of liquid water near the battery pack 18 and/or in the environment surrounding the vehicle 12 in the near future.

In a first exemplary embodiment, to determine the future moisture condition, the controller 14 predicts a future weather condition in the environment surrounding the vehicle 12. In an exemplary embodiment, the future weather condition includes one of: a future precipitation condition and a future non-precipitation condition. In the scope of the present disclosure, the future precipitation condition indicates that precipitation (e.g., rain, sleet, hail, snow, etc.) is predicted to occur in the environment surrounding the vehicle 12 in the near future. The future non-precipitation condition indicates that precipitation is not predicted to occur in the environment surrounding the vehicle 12 in the near future. If the future weather condition is the future precipitation condition, the future moisture condition is determined to be the future wet condition. If the future weather condition is the future non-precipitation condition, the future moisture condition is determined to be the future dry condition.

In a first exemplary embodiment, to determine the future weather condition, the controller 14 uses the vehicle communication system 26 to retrieve weather information a remote server. In a non-limiting example, the controller 14 uses the vehicle communication system 26 to transmit a current location of the vehicle 12 (as determined using, for example, a global navigation satellite system (GNSS)) to the remote server. The remote server responds with a message including weather information about the environment surrounding the vehicle 12, including predictions about the future weather condition (i.e., the future precipitation condition or the future non-precipitation condition).

It should be understood that additional methods for determining the future weather condition and/or future moisture condition, including, for example, methods based on the activation/deactivation state of vehicle systems (e.g., windshield wipers, headlights, running lights, fog lights, and/or the like) are within the scope of the present disclosure. In some embodiments, the controller 14 uses navigation route planning information to identify tunnels, overpasses, or other covered areas along the route of the vehicle 12 which may indicate the future dry condition. After block 402, the exemplary embodiment 400 proceeds to block 406, as will be discussed in greater detail below.

At block 404, the controller 14 identifies a future motion state of the vehicle 12. In an exemplary embodiment, the future motion state includes one of: a future moving state and a future still state. In the scope of the present disclosure, the future moving state indicates that the vehicle 12 is predicted to be in motion (e.g., driving, rolling, etc.) in the near future. The future still state indicates that the vehicle 12 is predicted to not be in motion (e.g., stopped, parked, etc.) in the near future.

In a first exemplary embodiment, to determine the future motion state, the controller 14 identifies a planned over-the-air (OTA) update event status. In an exemplary embodiment, the planned OTA update event status includes one of: an update planned status and an update not planned status. In the scope of the present disclosure, the update planned status indicates that one or more systems of the vehicle 12 (e.g., the controller 14) is scheduled to perform an OTA update (i.e., downloading/installing a software update from a remote server using the vehicle communication system 26) in the near future and that the vehicle 12 will be immobilized due to the OTA update process in the near future. The update not planned status indicates that no OTA update is planned in the near future. In an exemplary embodiment, to determine the OTA update event status, the controller 14 checks for the presence of a software flag saved in the media 22 indicating that an OTA update process is planned. In another exemplary embodiment, to determine the OTA update event status, the controller 14 uses the vehicle communication system 26 to retrieve a planned update schedule from a remote server. If the OTA update event status is the update planned status, the future motion state is determined to be the future still state.

In a second exemplary embodiment, to determine the future motion state, the controller 14 uses vehicle-to-everything (V2X) communication to communicate with nearby vehicles and/or traffic control infrastructure to determine a predicted timing and duration of one or more predicted vehicle stopping events. In the scope of the present disclosure, a predicted vehicle stopping event includes stopping due to traffic congestion or stopping due to road signs or traffic control devices. In a non-limiting example, the predicted timing and duration of the one or more predicted vehicle stopping events is determined based on traffic information and/or phase/timing of traffic control devices. The future motion state is determined to be the future still state in response to identifying the one or more predicted vehicle stopping events.

It should be understood that additional methods for determining the future motion state are within the scope of the present disclosure. After block 404 the exemplary embodiment 400 proceeds to block 406.

At block 406, the controller 14 plans the future pressure-relief breathing operation based at least in part on at least one of the future moisture condition determined at block 402 and the future motion state determined at block 404. In a non-limiting example, the future pressure-relief breathing operation is planned based on a timing and duration of at least one of the future moisture condition and the future motion state. In a first exemplary embodiment, the future pressure-relief breathing operation is planned to occur during the future dry condition and the future still state. In a second exemplary embodiment, the future pressure-relief breathing operation is planned to occur during the future dry condition and the future still state or the future moving state. In a third exemplary embodiment, the future pressure-relief breathing operation is planned to occur during the future wet condition or the future dry condition and the future still state. In a fourth exemplary embodiment, the future pressure-relief breathing operation is planned to occur during one of the one or more predicted vehicle stopping events. It should be understood that the above exemplary embodiments are merely illustrative in nature, and that any additional methods of planning the future pressure-relief breathing operation based at least in part on at least one of the future moisture condition and the future motion state are within the scope of the present disclosure. After block 406, the exemplary embodiment 400 is concluded, and the method 100 proceeds as discussed above.

The system 10 and method 100 of the present disclosure offer several advantages. By actively controlling the breathing vent 48, pressure equalization of the battery pack 18 may be accomplished while mitigating moisture ingress into the enclosure 40 of the battery pack 18. Using a tiered algorithm based on the low-pressure differential threshold, the intermediate-pressure differential threshold, and the high-pressure differential threshold, pressure equalization may be performed immediately, soon, or in the near future, based on design constraints of the battery pack 18. Furthermore, the system 10 and method 100 may be utilized to actively dry the air inside of the enclosure 40 when environmental conditions are conducive to drying. Accordingly, the system 10 and method 100 may result in an overall reduction of buildup of moisture within the enclosure 40 of the battery pack 18, resulting in increased performance, reliability, and lifespan of the battery pack 18.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for controlling a breathing vent for a battery pack of a vehicle, the method comprising:
determining a pressure differential between an interior pressure in an interior of the battery pack and an exterior pressure on an exterior of the battery pack; and
controlling the breathing vent to equalize the interior pressure with the exterior pressure based at least in part on the pressure differential.

2. The method of claim 1, wherein controlling the breathing vent further comprises:
comparing the pressure differential to an intermediate-pressure differential threshold;
determining a breathing readiness state in response to determining that the pressure differential is greater than or equal to the intermediate-pressure differential threshold, wherein the breathing readiness state includes one of: a breathing ready state and a breathing not-ready state; and
performing a pressure-relief breathing operation in response to determining that the breathing readiness state is the breathing ready state.

3. The method of claim 2, wherein determining the breathing readiness state further comprises:
identifying a moisture condition near the exterior of the battery pack, wherein the moisture condition includes one of: a wet condition and a dry condition;
determining the breathing readiness state to be the breathing ready state in response to determining that the moisture condition is the dry condition; and
determining the breathing readiness state to be the breathing not-ready state in response to determining that the moisture condition is the wet condition.

4. The method of claim 3, wherein identifying the moisture condition further comprises:
determining a weather condition in an environment surrounding the vehicle, wherein the weather condition includes one of: a precipitation condition and a non-precipitation condition; and
identifying the moisture condition to be the wet condition in response to determining that the weather condition is the precipitation condition.

5. The method of claim 4, wherein determining the weather condition further comprises:
performing a moisture measurement using at least one of: a vehicle exterior moisture sensor and a vehicle camera; and
determining the weather condition based at least in part on the moisture measurement.

6. The method of claim 2, wherein determining the breathing readiness state further comprises:
determining a motion state of the vehicle, wherein the motion state includes one of: a moving state and a still state; and
determining the breathing readiness state to be the breathing not-ready state in response to determining that the motion state is the moving state.

7. The method of claim 6, wherein determining the motion state further comprises:
identifying an over-the-air (OTA) update event status, wherein the OTA update event status includes one of: an updating status and a not-updating status; and
determining the motion state of the vehicle to be the still state in response to determining that the OTA update event status is the updating status.

8. The method of claim 1, wherein controlling the breathing vent further comprises:
comparing the pressure differential to a low-pressure differential threshold; and
planning a future pressure-relief breathing operation in response to determining that the pressure differential is greater than or equal to the low-pressure differential threshold, wherein planning the future pressure-relief breathing operation further comprises:
identifying one or more predicted vehicle stopping events; and
planning the future pressure-relief breathing operation to occur during one of the one or more predicted vehicle stopping events.

9. The method of claim 1, further comprising:
measuring an interior humidity in the interior of the battery pack;
measuring an exterior humidity on the exterior of the battery pack; and
performing a humidity-relief breathing operation in response to determining that the interior humidity is greater than the exterior humidity.

10. The method of claim 1, further comprising:
comparing the pressure differential to a high-pressure differential threshold; and
performing a pressure-relief breathing operation in response to determining that the pressure differential is greater than or equal to the high-pressure differential threshold.

11. A system for controlling a breathing vent for a battery pack of a vehicle, the system comprising:
the battery pack including an interior pressure sensor disposed in an interior of the battery pack, an exterior pressure sensor disposed on an exterior of the battery pack, and the breathing vent, wherein the breathing vent is actively controllable to regulate airflow between the interior of the battery pack and the exterior of the battery pack;
a controller in electrical communication with the interior pressure sensor, the exterior pressure sensor, and the breathing vent, wherein the controller is programmed to:
measure an interior pressure using the interior pressure sensor;
measure an exterior pressure using the exterior pressure sensor;
determine a pressure differential between the interior pressure and the exterior pressure; and
control the breathing vent to equalize the interior pressure with the exterior pressure based at least in part on the pressure differential.

12. The system of claim 11, wherein to control the breathing vent, the controller is further programmed to:
compare the pressure differential to an intermediate-pressure differential threshold;
compare the pressure differential to a high-pressure differential threshold, wherein the high-pressure differential threshold is greater than the intermediate-pressure differential threshold;
determine a breathing readiness state in response to determining that the pressure differential is greater than or equal to the intermediate-pressure differential threshold, wherein the breathing readiness state includes one of: a breathing ready state and a breathing not-ready state;
perform a pressure-relief breathing operation in response to determining that the breathing readiness state is the breathing ready state; and
perform the pressure-relief breathing operation in response to determining that the pressure differential is greater than or equal to the high-pressure differential threshold.

13. The system of claim 12, wherein to determine the breathing readiness state, the controller is further programmed to:
identify a moisture condition near the exterior of the battery pack, wherein the moisture condition includes one of: a wet condition and a dry condition;
determine the breathing readiness state to be the breathing ready state in response to determining that the moisture condition is the dry condition; and
determine the breathing readiness state to be the breathing not-ready state in response to determining that the moisture condition is the wet condition.

14. The system of claim 13, further comprising at least one of: a vehicle exterior moisture sensor in electrical communication with the controller and a vehicle camera in electrical communication with the controller, wherein to identify the moisture condition, the controller is further programmed to:
perform a moisture measurement using at least one of: the vehicle exterior moisture sensor and the vehicle camera; and
determine the moisture condition based at least in part on the moisture measurement.

15. The system of claim 13, wherein the controller is further programmed to:
determine a motion state of the vehicle, wherein the motion state includes one of: a moving state and a still state; and
determine the breathing readiness state to be the breathing not-ready state in response to determining that the moisture condition is the wet condition and the motion state is the moving state.

16. The system of claim 15, wherein to determine the motion state of the vehicle, the controller is further programmed to:
identify an over-the-air (OTA) update event status, wherein the OTA update event status includes one of: an updating status and a not-updating status; and
determine the motion state of the vehicle to be the still state in response to determining that the OTA update event status is the updating status.

17. The system of claim 11, the battery pack further comprising an interior humidity sensor in electrical communication with the controller and disposed in the interior of the battery pack and an exterior humidity sensor in electrical communication with the controller and disposed on the exterior of the battery pack, wherein the controller is further programmed to:
measure an interior humidity using the interior humidity sensor;
measure an exterior humidity using the exterior humidity sensor; and
perform a humidity-relief breathing operation in response to determining that the interior humidity is greater than the exterior humidity.

18. A method for controlling a breathing vent for a battery pack of a vehicle, the method comprising:
determining a pressure differential between an interior pressure in an interior of the battery pack and an exterior pressure on an exterior of the battery pack;
measuring an interior humidity in the interior of the battery pack and an exterior humidity on the exterior of the battery pack;
comparing the pressure differential to an intermediate-pressure differential threshold;
determining a breathing readiness state in response to determining that the pressure differential is greater than or equal to the intermediate-pressure differential threshold, wherein the breathing readiness state includes one of: a breathing ready state and a breathing not-ready state;
comparing the pressure differential to a high-pressure differential threshold, wherein the high-pressure differential threshold is greater than the intermediate-pressure differential threshold;
performing a pressure-relief breathing operation in response to determining that the breathing readiness state is the breathing ready state or the pressure differential is greater than or equal to the high-pressure differential threshold; and
performing a humidity-relief breathing operation in response to determining that the interior humidity is greater than the exterior humidity and the breathing readiness state is the breathing ready state.

19. The method of claim 18, wherein determining the breathing readiness state further comprises:
identifying a moisture condition near the exterior of the battery pack, wherein the moisture condition includes one of: a wet condition and a dry condition;
determining a motion state of the vehicle, wherein the motion state includes one of: a moving state and a still state;
determining the breathing readiness state to be the breathing ready state in response to determining that the moisture condition is the dry condition or the motion state is the still state; and
determining the breathing readiness state to be the breathing not-ready state in response to determining that the moisture condition is the wet condition and the motion state is the moving state.

20. The method of claim 19, further comprising:
comparing the pressure differential to a low-pressure differential threshold; and
planning a future pressure-relief breathing operation in response to determining that the pressure differential is greater than or equal to the low-pressure differential threshold, wherein planning the future pressure-relief breathing operation further comprises:
identifying one or more predicted vehicle stopping events; and
planning the future pressure-relief breathing operation to occur during one of the one or more predicted vehicle stopping events.
